(19) United States
(12) Patent Application Publication
(10) Pub. No.: US 2023/0011164 A1
(43) Pub. Date: Jan. 12, 2023

(54) TOOL PART FOR CONNECTING TO A TOOL COUNTER-PART, TOOL COUNTER-PART FOR CONNECTING TO A TOOL PART, AND TOOL

(71) Applicant: Mapal Fabrik für Präzisionswerkzeuge Dr. Kress KG, Aalen (DE)

(72) Inventor: Jochen KRESS, Aalen (DE)

(73) Assignee: Mapal Fabrik für Präzisionswerkzeuge Dr. Kress KG, Aalen (DE)

(21) Appl. No.: 17/785,194

(22) PCT Filed: Dec. 16, 2020
(86) PCT No.: PCT/EP2020/086529

§ 371 Date: Jun. 14, 2022

(30) Foreign Application Priority Data
Dec. 18, 2019 (DE) 10 2019 220 092.3

(51) Int. Cl. B23B 31/11; B23C 5/10

(52) U.S. Cl. CPC B23B 31/1122; B23C 5/10

(57) ABSTRACT

The invention relates to a tool part adapted to be connected to a tool counterpart, wherein the tool part comprises a centering portion and an axial stop, and wherein the tool part comprises a plug-rotation portion adapted to cooperate with a plug-rotation counterpart portion of the tool counterpart to connect the tool part to the tool counterpart.

The invention relates to a tool part adapted to be connected to a tool counterpart, such a tool counterpart adapted to be connected to the tool part, and a tool comprising such a tool part and such a tool counterpart.

Complex tools are composed of different parts, in particular in order to be able to replace machining heads in particular, which are also referred to as exchange heads, as required or in the event of wear or damage. Connecting points or interfaces are set up between the various parts of such a tool, via which the various parts are mechanically connected to one another and aligned relative to one another. Such interfaces can also be used to make a tool longer or shorter as required. It should be possible to connect and disconnect parts of the tool easily and quickly in the area of the interface, and the alignment of the parts relative to one another should also be as precise as possible—in particular with regard to an axial position and a radial position.

DE 100 48 910 A1 shows a connecting point in which a hollow conical recess cooperates with a conical projection to provide radial centering, with abutting flat surfaces being provided in the joined state to define the axial position. The two parts of the tool are clamped together in the axial direction by means of a clamping device when the connecting point is assembled. This connecting point or interface is also known as the HFS interface.

In such a connection point, the clamping of the individual parts against each other is typically performed by means of a double-threaded spindle, as also shown for example in DE 101 12 966 A1. Thus, an additional part is required, namely the double-threaded spindle, as well as at least one further part for its actuation. In addition, the manufacture of an internal thread for the engagement of the double-threaded spindle, particularly in carbide bodies, is complex and expensive. However, straight change heads typically have a base body made of hard metal. The clamping process takes a comparatively long time with such a system and is also subject to errors.

An interface with radial clamping system is known from DE 103 26 928 A1, wherein the radial clamping system has an eccentric bolt. With such a system, the clamping process is fast and uncomplicated, but the system has even more parts and is even more expensive to manufacture. In addition, the eccentric bolt introduces radial forces that ultimately cause one part of the tool to tilt relative to another, reducing clamping accuracy.

The invention is based on the problem of creating a tool part, a tool counterpart and a tool, wherein the mentioned disadvantages do not occur.

The problem is solved by providing the present technical teaching, in particular the teaching of the independent claims as well as the embodiments disclosed in the dependent claims and the description.

In particular, the problem is solved by providing a tool part adapted to be connected to a tool counterpart, wherein the tool part comprises a centering portion and an axial stop. The tool part further comprises a plug-rotation portion adapted to cooperate with a plug-rotation counterpart portion of the tool counterpart to connect the tool part to the tool counterpart. With the plug-rotation portion, a simple, small and, in particular, short, functionally reliable and, with regard to a positioning of the tool part relative to the tool counterpart, very precise possibility is created of firmly and stably connecting the tool part to the tool counterpart. In particular, no additional parts are required, and the manufacture of the plug-rotation portion is also inexpensive and involves little effort.

The tool part is in particular a first part of a connecting point or interface of a tool, wherein a second part of this interface or connecting point is the corresponding tool counterpart to which the tool part is connected as intended. A tool may in particular comprise the tool part and the tool counterpart, according to one embodiment also comprising them; however, it is also possible for the tool to comprise a larger number of parts, wherein in this case the tool in particular comprises a plurality of such intersection or connection points.

The tool part can in particular be a tool head or machining head. The tool counterpart can in particular be a holder which is directly part of a machine tool, or which in turn can be inserted into a machine tool and fixed there. However, the tool counterpart can also be an extension piece, an intermediate part, or the like. Also, the tool part may be an extension piece or intermediate part or the like. In particular, it is possible that the tool part and the tool counterpart are configured as extension pieces or intermediate parts, which in turn can then be connected in particular again to further extension pieces or intermediate parts, or a tool head or machining head, or a holder.

In particular, the plug-rotation portion is set up to cooperate with the plug-rotation counterpart portion of the tool counterpart in such a way that the tool part is firmly connected to the tool counterpart, in particular in the direction of a longitudinal axis of the tool part and/or the tool.

In particular, the plug-rotation portion of the tool part and the plug-rotation counterpart portion of the tool counterpart preferably together form a plug-rotation mechanism.

Such a plug-rotation mechanism is determined in particular by the fact that the parts connected via it are first brought into connection with one another by means of an axial plug movement and then fixed to one another by means of a rotation movement. In this case, a plug path covered during the plug movement is preferably longer, in particular much longer, than an axial path, also referred to as a rotational path, covered during the rotation movement of the plug-rotation mechanism from a first engagement of the elements to be twisted against each other to an axial stop of the parts against each other.

For fastening the tool part to the tool counterpart by means of the plug-rotation mechanism, therefore, the tool part in particular is first displaced in the axial direction relative to the tool counterpart in a plug movement—in particular without a rotation movement—and is then rotated relative to the tool counterpart in order to effect a firm and stable connection.

The plug-rotation portion is configured in particular and matched to the plug-rotation counterpart portion in such a way that the axial movement resulting from the rotation movement following the plug movement takes place in the same direction as the preceding plug movement. During the rotation movement of the plug-rotation portion for connecting the tool part to the tool counterpart, the tool part is pulled against the tool counterpart in particular. In particular, the tool part is thereby displaced in the direction of the tool counterpart.

According to a preferred embodiment, the plug-rotation mechanism is configured as a bayonet mechanism.

A longitudinal axis of the tool part, the tool counterpart and/or the tool is in particular an axis which extends along a longest extension of the corresponding part, and/or which defines an axis of symmetry of the corresponding part, and/or which coincides with an intended axis of rotation of the corresponding part during machining of a workpiece. An axial direction extends along the longitudinal axis; a radial direction is perpendicular to the longitudinal axis, and a circumferential direction extends in particular concentrically about the longitudinal axis.

The plug movement of the plug-rotation mechanism takes place in particular in the direction of the longitudinal axis, i.e. in the axial direction; the rotation movement of the plug-rotation mechanism takes place in particular in the circumferential direction, i.e. about the longitudinal axis.

In particular, the centering portion is adapted to effect centering of the tool part relative to the tool counterpart in the radial direction, i.e. perpendicular to the longitudinal axis.

In particular, the axial stop is adapted to determine the axial position of the tool part, that is, the position of the tool part in the direction of the longitudinal axis, relative to the tool counterpart when the tool part is connected to the tool counterpart.

According to a further development of the invention, it is provided that the plug-rotation portion has at least one clamping ramp extending along a helical section line. This represents a particularly simple, short and easy to manufacture design of the plug-rotation portion. In this context, a helical section line means in particular a line which extends along a section of a helical line about the longitudinal axis, in particular by at most 180°, preferably by less than 180°.

Unlike a thread, there is therefore no need to cut threads which fully wrap around the longitudinal axis, in particular several times fully wrap around the longitudinal axis. In particular, the clamping ramp is adapted in such a way that a clamping projection of the tool counterpart can slide or run on the clamping ramp when the tool part is connected to the tool counterpart, in particular during the rotation movement of the plug-rotation mechanism. Because the clamping ramp extends along the helical section line, an axial relative movement between the tool part and the tool counterpart is effected at the same time during the rotation movement, in particular in such a way that they are clamped together.

The at least one clamping ramp realizes in particular a clamping wedge, wherein it realizes a wedge gear together with the clamping projection of the tool counterpart, so that during clamping, in particular during the rotation movement of the clamping-rotation mechanism, the tool part is pulled against the tool counterpart with high force.

According to a further development of the invention, the plug-rotation portion has two clamping ramps. In this way, a particularly effective clamping with the tool counterpart can be achieved. Preferably, both clamping ramps each extend along an associated helical section line. The two clamping ramps are preferably arranged offset from one another in the circumferential direction on the plug-rotation portion, preferably offset by 180° or at least approximately 180° relative to one another.

Preferably, the two clamping ramps—in particular with regard to equivalent points on the clamping ramps—are arranged at the same axial height or in the same axial position relative to each other on the plug-rotation portion. In particular, one beginning and one end of the clamping ramps are preferably arranged at the same axial height relative to each other. In this way, it is advantageously avoided that the tool part tilts during clamping with the tool counterpart; in particular, an introduction of transverse forces transverse to the longitudinal axis during twisting of the tool part relative to the tool counterpart is avoided.

Alternatively or additionally, it is preferred that the two clamping ramps have identical pitches.

Particularly preferably, the two clamping ramps are identical to each other.

The pitch of the at least one clamping ramp, preferably the pitch of both clamping ramps, is preferably selected such that self-locking results in the region of the at least one clamping ramp in the plug-rotation mechanism. In particular, self-locking preferably results between the at least one clamping projection of the tool counterpart and the at least one clamping ramp of the tool part. In this way, a particularly effective fixing of the tool part to the tool counterpart is advantageously achieved.

The pitch of the at least one clamping ramp, preferably both clamping ramps, is preferably about 15°, preferably 15°, in particular when steel is paired with steel.

Preferably, each of the two clamping ramps is adapted to cooperate in each case with a clamping projection of the tool counterpart, wherein the latter preferably has two clamping projections accordingly.

According to a further development of the invention, it is provided that the at least one clamping ramp, preferably each of the clamping ramps, extends preferably by at least 90° to at most 180°, preferably at least 95° to at most 120°, about the longitudinal axis at the plug-rotation portion. Thus, only a comparatively small rotation movement about a comparatively small angular range is required to clamp the tool part to the tool counterpart. At the same time, clamping with high force is achieved.

According to a further development of the invention, it is provided that the plug-rotation portion has at least one insertion surface which is adapted to cooperate with an insertion counter surface of the tool counterpart in order to enable insertion of the tool part into the tool counterpart only in at least one specific angular position about the longitudinal axis. The insertion surfaces thereby define, in cooperation with the insertion counter surfaces, a joining position for joining the tool part to the tool counterpart. Particularly preferably, they allow the insertion of the tool part into the tool counterpart in at most one specific angular position, or in at most two, in particular equivalent, angular positions offset by 180° relative to each other.

Preferably, the plug-rotation portion has two insertion surfaces which are appropriately adatped to cooperate with two insertion counter surfaces of the tool counterpart. Preferably, the two insertion surfaces are arranged or configured at least substantially parallel to one another, preferably oriented parallel to one another, and/or opposite one another transversely to the longitudinal direction on the plug-rotation portion.

Preferably, the at least one insertion surface is formed as a planar surface. In particular, the at least one insertion surface preferably encloses an angle with the longitudinal axis which deviates only at most slightly from 0°, wherein the angle is in particular at most 5°, preferably at most 4°, preferably at most 2°, preferably at most 1°, preferably at most 0.5°. Particularly preferably, the angle is 0°, that is, the longitudinal direction lies in the insertion surface, or the insertion surface extends along the longitudinal direction.

The at least one insertion counter surface of the tool counterpart is preferably configured to be correspondingly complementary to the at least one insertion surface.

According to a further development of the invention, it is provided that the plug-rotation portion adjoins the centering portion in the axial direction. Accordingly, in this embodiment, a functional separation is provided between the centering portion on the one hand and the plug-rotation portion on the other. Thus, on the one hand, the centering function of the centering portion and, on the other hand, the fastening function of the plug-rotation portion can be optimized. Preferably, the plug-rotation portion is configured as a clamping extension of the tool part, which extends in particular from the centering portion in the axial direction—in the assembled state in the direction of the tool counterpart.

According to a further development of the invention, it is provided that the centering portion has an outer cone or is configured as an outer cone, in particular as a conical projection, in particular as a short cone. This permits particularly good centering of the tool part on the tool counterpart, in particular if the centering portion configured as an outer cone interacts with a centering counter-portion of the tool counterpart configured as an inner cone.

Alternatively or additionally, the axial stop is preferably configured as an axial annular surface, in particular as an annular surface whose normal vector points at least essentially in the longitudinal direction, preferably exactly in the longitudinal direction, or encloses at most a small angle, at most of a few degrees, in particular at most 5°, preferably at most 4°, preferably at most 3°, preferably at most 2°, preferably at most 1°, preferably at most 0.5°, with the longitudinal direction. The axial annular surface preferably embraces the centering portion, in particular annularly, in particular along a closed circumferential line.

In particular, the centering portion and the axial stop are preferably configured together as a short cone interface with face contact, especially as in the embodiment shown in DE 100 48 910 A1.

According to a further development of the invention, it is provided that the tool part has a machining portion with at least one cutting edge. In this embodiment, the tool part is advantageously configured as a tool head, in particular as an exchangeable head. The at least one cutting edge is preferably a geometrically defined cutting edge. In a preferred embodiment, the at least one cutting edge can be provided on the tool part in one piece, in particular in one material, or in multiple parts, in particular as an inserted, glued-in or soldered-in cutting edge, or as an interchangeable cutting edge.

In particular, the tool part can be configured as a milling head, preferably made of solid carbide, or as a milling head with a brazed-in cutting edge, or as a drill, reamer, or reaming tool.

The machining portion is preferably arranged axially adjacent to the centering portion opposite the plug-rotation portion. In particular, the machining portion is arranged at a distal end of the tool part that is intended to face a workpiece, wherein the plug-rotation portion is arranged at a proximal end of the tool part that is intended to face away from a workpiece. The centering portion and the axial stop are arranged between the distal end and the proximal end.

Preferably, driving elements, in particular wrench flats, are formed on the tool part, which serve to engage a clamping means by means of which the tool part and the tool counterpart can be clamped together. The wrench flats can in particular be adapted in such a way that an open-end wrench can engage with them.

The problem is also solved by providing a tool counterpart adapted to be connected to a tool part, in particular to a tool part according to the invention or to a tool part according to one of the previously described embodiments. The tool counterpart comprises a centering counter-portion and an axial counterstop, as well as a plug-rotation counterpart portion adapted to cooperate with the plug-rotation portion of the tool part to connect the tool counterpart to the tool part. In connection with the tool counterpart, in particular the advantages already explained previously in connection with the tool part are realized. In particular, the tool counterpart is preferably configured with respect to at least one feature as already explicitly or implicitly explained previously in connection with the tool part.

The plug-rotation counterpart portion is configured in particular and matched to the plug-rotation portion in such a way that the axial movement resulting from the rotation movement following the plug movement takes place in the same direction as the preceding plug movement. During the rotation movement of the plug-rotation portion for connecting the tool part to the tool counterpart, the tool part is pulled in particular against the tool counterpart. In particular, the tool part is thereby displaced in the direction of the tool counterpart.

According to a further development of the invention, it is provided that the plug-rotation counterpart portion has at least one clamping projection, preferably a clamping cam. The at least one clamping projection is adapted to cooperate with the at least one clamping ramp of the tool part, in particular in such a way that the tool part is displaced in the direction of the tool counterpart, in particular is urged in the axial direction against the tool counterpart, in particular is clamped with the tool counterpart, when a relative rotation—about the longitudinal axis—is effected between the tool part and the tool counterpart, in particular between the at least one clamping ramp and the at least one clamping projection, in particular in such a way that the at least one clamping projection runs on the at least one clamping ramp.

In particular, the plug-rotation counterpart portion preferably has two clamping projections, wherein each clamping projection preferably is adapted to cooperate with a respective one of the two clamping ramps which the plug-rotation portion of the tool part preferably has. The two clamping projections are preferably arranged diametrically opposite each other on the tool counterpart. In particular, the two clamping projections are preferably arranged at the same axial height on the tool counterpart. As already explained, this has the advantage that no tilting moment is introduced into the tool part relative to the tool counterpart when the tool part is clamped with the tool counterpart.

According to a further development of the invention, it is provided that the centering counter-portion has an inner cone which is in particular arranged and adapted to cooperate with the outer cone of the centering portion of the tool part in order to center the tool part relative to the tool counterpart. Accordingly, the centering counter-portion is configured in particular as a conical or conical-portion-shaped recess into which the centering portion of the tool part, which is configured as a conical projection or conical extension, can be inserted.

Preferably, the centering counter-portion configured as an inner cone is more elastic, i.e. more elastically deformable, than the centering portion configured as an outer cone, so that the inner cone of the centering counter-portion is deformed, in particular expanded, by the outer cone of the centering portion when the tool part is clamped to the tool counterpart. In interaction with the axial stop and the axial counterstop, an overdetermination is thus achieved in particular, so that the tool part is fixed very firmly, stably and positionally securely relative to the tool counterpart.

The axial counterstop is preferably configured as an axial annular counter surface, i.e. as an annular surface whose normal vector is preferably oriented parallel to the longitudinal direction or encloses at most a small angle, at most of a few degrees, in particular at most 5°, preferably at most 4°, preferably at most 3°, preferably at most 2°, preferably at most 1°, preferably at most 0.5°, with the longitudinal direction. Preferably, the axial annular counter surface embraces the inner cone of the centering counter-portion, in particular annularly, in particular along a closed circumferential line.

In the clamped state, the axial annular surface of the axial stop preferably abuts the axial annular counter surface of the axial counterstop, in particular these surfaces preferably lie against each other over their entire surface. In this way in particular, the overdetermination already described in connection with the expansion of the inner cone of the centering counter-portion is achieved.

According to a further development of the invention, it is provided that the tool counterpart has a shank portion or a clamping portion, wherein the shank portion or clamping portion preferably is arranged for connecting the tool counterpart to a machine tool, in particular to a spindle of a machine tool.

The shank portion of the tool counterpart preferably has a hollow shank taper interface, in particular for connection to a spindle of a machine tool.

In a preferred embodiment, the tool part has a machining portion with at least one cutting edge, wherein at the same time the tool counterpart has the shank or clamping portion.

Finally, the problem is also solved by providing a tool which has at least one tool part according to the invention or at least one tool part according to one of the embodiments described above, as well as at least one tool counterpart according to the invention or at least one tool counterpart according to one of the embodiments described above, which are preferably connectable to one another, in particular connected to one another. In connection with the tool, in particular the advantages already explained in connection with the tool part on the one hand and the tool counterpart on the other hand are realized. The tool has, in particular, an interface or connection point which is formed by the tool part and the tool counterpart and is formed, in particular, in the connection region between the tool part and the tool counterpart.

The invention is explained in more detail below with reference to the drawing. Thereby show:

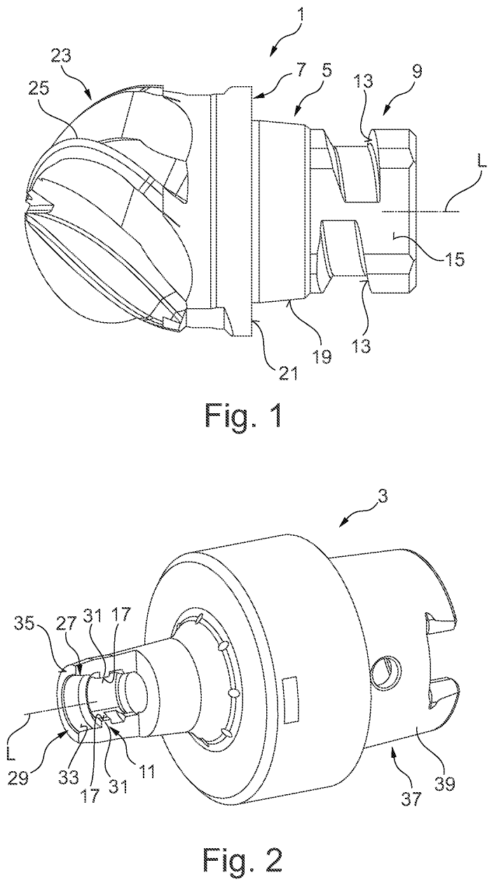

FIG. 1 a representation of an embodiment of a tool part;

FIG. 2 a representation of an embodiment of a tool counterpart;

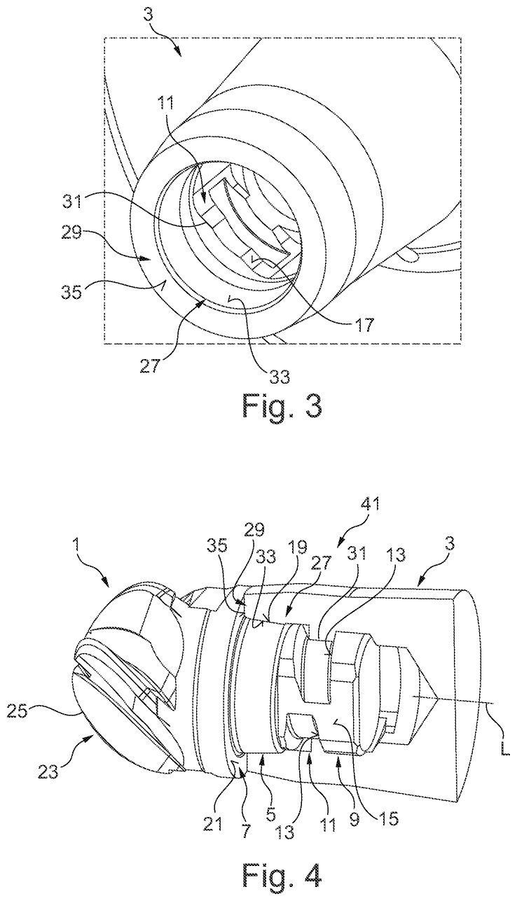

FIG. 3 a detailed representation of the tool counterpart according to FIG. 2, and

FIG. 4 the tool part according to FIG. 1 in the connected state with the tool counterpart according to FIG. 2.

FIG. 1 shows a schematic representation of an embodiment of a tool part 1 which is arranged to be connected to an embodiment of a tool counterpart 3 shown in FIG. 2. With reference to FIG. 1, the tool part 1 has a centering portion 5 and an axial stop 7. In addition, the tool part 1 has a plug-rotation portion 9 which is adapted to cooperate with a plug-rotation counterpart portion 11 of the tool counterpart 3, again shown in FIG. 2, in order to connect the tool part 1 to the tool counterpart 3. The plug-rotation portion 9 and the plug-rotation counterpart portion 11 together form in particular a plug-rotation mechanism, preferably a bayonet lock. The tool part 1 is connected to the tool counterpart 3 by first performing a plug movement in the direction of a longitudinal axis L, that is in the axial direction, and then a rotation movement follows, during which the tool part 1 is rotated relative to the tool counterpart 3, whereby a fixing of the tool part 1 to the tool counterpart 3 is achieved. The plug path is thereby longer, preferably much longer, than an axial displacement path along the longitudinal direction L, also referred to as an axial rotation path, which is covered from the first start of a rotation movement of the plug-rotation mechanism during the rotation movement to the axial stop of the tool part 1 on the tool counterpart 3 and thus to the end of the fixation of the tool part 1 on the tool counterpart 3.

In this way, a very compact, easy-to-use, component-saving and functionally reliable solution is provided for connecting the tool part 1 to the tool counterpart 3, which is also short in the axial direction.

The plug-rotation portion 9 preferably has at least one clamping ramp 13, in this case two clamping ramps 13, running along a helical section line—around the longitudinal axis L. The two clamping ramps 13 are preferably arranged in an identical axial position, wherein, in particular, their starting and end points each are arranged at the same axial height—as seen in the direction of the longitudinal axis L. The two clamping ramps 13 are preferably arranged diametrically opposite each other, in particular offset from each other in the circumferential direction by approximately 180°, preferably by 180°.

The clamping ramps 13 each extend preferably by at least 90° to at most 180°, preferably by at least 95° to at most 120°, in the circumferential direction about the longitudinal axis L.

Preferably, the plug-rotation portion 9 adjoins the centering portion 5 in the axial direction, i.e. in the direction of the longitudinal axis L. In particular, the plug-rotation portion 9 is preferably configured as a clamping extension.

The plug-rotation portion 9 preferably has at least one insertion surface 15 which is adapted to cooperate with an insertion counter surface 17 of the tool counterpart 3—compare FIG. 2—in order to permit insertion of the tool part 1 into the tool counterpart 3 only in at least one specific angular position, preferably in at most one or in at most two specific angular positions about the longitudinal axis L.

Preferably, two such insertion surfaces 15 are provided, wherein in FIG. 1 only one of the insertion surfaces 15 faces the viewer and is therefore shown. The other insertion surface 15 is preferably formed or arranged diametrically opposite on the plug-rotation portion 9, so that it is hidden from the viewer.

Accordingly, the tool counterpart 3 also preferably has two insertion counter surfaces 17.

The centering portion 5 is preferably configured as an outer cone 19. The axial stop 7 is preferably configured as an axial annular surface 21 which embraces the centering portion 5 along a closed circumferential line.

The centering portion 5 is configured here in particular as a short cone. The axial stop 7 is configured in particular as a flat surface.

The tool part 1 preferably has a machining portion 23, which in turn preferably has at least one cutting edge 25, in particular at least one geometrically defined cutting edge 25, preferably a plurality of geometrically defined cutting edges 25. The machining portion 23 is thereby arranged—adjoining the centering portion 5—opposite the plug-rotation portion 9, so that the centering portion 5—seen along the longitudinal axis L—is arranged between the machining portion 23 and the plug-rotation portion 9.

The tool part 1 is configured here in particular as a machining head, especially preferably as a milling head. The cutting edge 25 can be configured as a soldered-in cutting edge, an inserted cutting edge, or can also be formed in one piece and in particular in one material with the machining portion 23. The tool part 1 can also be configured as a drill, reamer or reaming tool, or in another suitable manner.

FIG. 2 shows a representation of an embodiment of the tool counterpart 3. Identical and functionally identical elements are provided with the same reference signs in all figures, so that reference is made to the preceding description in each case.

The tool counterpart 3 according to FIG. 2 is shown partially cut in the area of its connection point to the tool part 1.

In particular, the tool counterpart 3 has a centering counter-portion 27 adapted to cooperate with the centering portion 5 and an axial counterstop 29 adapted to cooperate with the axial stop 7. In addition, the tool counterpart 3 has the plug-rotation counterpart portion 11.

This in turn has at least one clamping projection 31, which is arranged to cooperate with the at least one clamping ramp 13 in such a way that the tool part 1 is urged against the tool counterpart 3, in particular drawn into the tool counterpart 3 and ultimately clamped to the tool counterpart 3 when the tool part 1 is rotated relative to the tool counterpart 3, in particular when the at least one clamping projection 31 runs on the at least one clamping ramp 13. In the embodiment shown here, two clamping projections 31 are provided which are diametrically opposite each other in particular.

The centering counter-portion 27 is preferably configured here as an inner cone 33, which is preferably more elastic than the outer cone 19, so that the inner cone 33, in particular a wall of the inner cone 33, is widened at least in certain areas when the outer cone 19 is drawn into the inner cone 33 by the plug-rotation mechanism.

The axial counterstop 29 is configured here in particular as an axial annular counter surface 35, which in particular engages around the inner cone 33 along a closed circumferential line. In the mutually clamped state of the tool part 1 with the tool counterpart 3, the axial annular surface 21 preferably lies fully and firmly against the axial annular counter surface 35.

Overall, the outer cone 19 and the inner cone 33 together effect radial positioning of the tool part 1 relative to the tool counterpart 3, wherein the axial annular surface 21 interacts with the axial annular counter surface 35 to define an axial relative position between the tool part 1 and the tool counterpart 3 when they are clamped together.

The tool counterpart 3 further comprises a shank portion 37 which is adapted for connection to a machine tool, in particular to a spindle of a machine tool. The shank portion 37 preferably has a hollow shank taper 39.

FIG. 3 shows a detailed representation of the tool counterpart 3 according to FIG. 2, in which one of the clamping projections 31 is clearly visible, as well as one of the insertion counter surfaces 17, the inner cone 33 and the annular counter surface 35.

FIG. 4 shows a detailed representation of a tool 41, which comprises the tool part 1 and the tool counterpart 3 in an interconnected state, wherein the tool 41 preferably comprises the tool part 1 and the tool counterpart 3.

Only a detail of the tool counterpart 3 is shown here in longitudinal sectional view, while the tool part 1 is shown uncut in the tool counterpart 3 or connected to the tool counterpart 3. For clamping the tool part 1 to the tool counterpart 3, the plug-rotation portion 9 is preferably first inserted axially into the plug-rotation counterpart portion 11. In this case, the insertion surfaces 15 in interaction with the insertion counter surfaces 17 define an angular position about the longitudinal axis L for axial insertion or insertion. If the clamping ramps 13 are arranged at the level of the clamping projections 31, the tool part 1 is preferably rotated relative to the tool counterpart 3 by approximately 90°, preferably slightly more than 90°, in the clamping direction, wherein the clamping projections 31 run on the clamping ramps 13—or vice versa—and wherein the tool part 1, in particular the outer cone 19, is drawn deeper into the tool counterpart 3, in particular into the inner cone 33, in particular until the annular surface 21 abuts against the annular counter surface 35. In this process, the inner cone 33 is preferably widened at least in some areas, in particular slightly, so that the result is an overdetermination and thus a highly accurate and stable fixing of the tool part 1 to the tool counterpart 3.

Overall, this provides a low-cost, short-barrel, precise, stable, easy-to-use, and low-component way to connect the tool part 1 to the tool counterpart 3.

1. Tool part adapted to be connected to a tool counterpart, wherein the tool part comprises a centering portion and an axial stop, and wherein the tool part comprises a plug-rotation portion adapted to cooperate with a plug-rotation counterpart portion of the tool counterpart to connect the tool part to the tool counterpart.

2. Tool part according to claim 1, wherein the plug-rotation portion has at least one clamping ramp running along a helical section line.

3. Tool part according to claim 1, wherein the plug-rotation portion has two clamping ramps wherein the two clamping ramps preferably are arranged in identical axial position to one another.

4. Tool part according to claim 1, wherein the at least one clamping ramp extends by at least 90° to at most 180°, preferably by at least 95° to at most 120°, about a longitudinal axis (L) of the tool part at the plug-rotation portion.

5. Tool part according to claim 1, wherein the plug-rotation portion comprises at least one insertion surface adapted to cooperate with an insertion counter surface of the tool counterpart to allow insertion of the tool part into the tool counterpart only in at least one determined angular position about a longitudinal axis.

6. Tool part according to claim 1, wherein the plug-rotation portion adjoins the centering portion in an axial direction.

7. Tool part according to claim 1, wherein the centering portion has an outer cone, and/or in that the axial stop is configured as an axial annular surface which engages around the centering portion.

8. Tool part according to claim 1, wherein the tool part has a machining portion with at least one cutting edge.

9. Tool counterpart adapted to be connected to a tool part according to one claim 1, comprising a centering counter-portion and an axial counterstop, wherein the tool counterpart comprises a plug-rotation counterpart portion adapted to cooperate with a plug-rotation portion of the tool part to connect the tool counterpart to the tool part.

10. Tool counterpart according to claim 9, wherein the plug-rotation counterpart portion has at least one clamping projection which is arranged to cooperate with at least one clamping ramp of the plug-rotation portion (9) of the tool part, in such a way, that the tool part is displaced in a direction of the tool counterpart when a relative rotation is effected between the tool part and the tool counterpart, in particular between the at least one clamping projection and the at least one clamping ramp.

11. Tool counterpart according to claim 9, wherein the centering counter-portion has an inner cone, and/or in that the axial counterstop is configured as an axial annular counter surface which engages around the centering counter-portion.

12. Tool counterpart according to claim 1, wherein the tool counterpart comprises a shank portion preferably adapted for connecting the tool counterpart to a machine tool.

13. Tool comprising a tool part according to claim 1 and the tool counterpart, the tool counterpart comprising a centering counter-portion and an axial counterstop, wherein the tool counterpart comprises a plug-rotation counterpart portion adapted to cooperate with the plug-rotation portion of the tool part to connect the tool counterpart to the tool part.

14. Tool according to claim 13, wherein the plug-rotation counterpart portion has at least one clamping projection which is arranged to cooperate with at least one clamping ramp of the plug-rotation portion (9) of the tool part in such a way, that the tool part is displaced in a direction of the tool counterpart when a relative rotation is effected between the tool part and the tool counterpart, in particular between the at least one clamping projection and the at least one clamping ramp.

15. Tool according to claim 13, wherein the centering counter-portion has an inner cone, and/or in that the axial counterstop is configured as an axial annular counter surface which engages around the centering counter-portion.

16. Tool according to claim 13, wherein the tool counterpart comprises a shank portion preferably adapted for connecting the tool counterpart to a machine tool.
